(19) United States
(12) Patent Application Publication
(10) Pub. No.: US 2025/0310067 A1
(43) Pub. Date: Oct. 2, 2025

(54) WIRELESS NETWORK-BASED POSTURE DETECTION METHOD, DEVICE, APPARATUS, AND STORAGE MEDIUM

(71) Applicant: OUPIIN ELECTRONIC(KUNSHAN) CO., LTD, Kunshan City (CN)

(72) Inventor: Hsin Chih CHEN, Kunshan City (CN)

(21) Appl. No.: 18/744,647

(22) Filed: Jun. 16, 2024

(30) Foreign Application Priority Data
Mar. 28, 2024 (CN) 202410370309.3

(51) Int. Cl. H04L 5/00; H04B 7/06; H04W 48/16

(52) U.S. Cl. CPC H04L 5/0098; H04B 7/0626; H04W 48/16

(57) ABSTRACT

The present application discloses a wireless network-based posture detection method, device, electronic apparatus, and storage medium. The method includes obtaining channel state information collected by a signal collection device from a wireless network, denoising the channel state information and extracting features from the denoised channel state information to obtain target feature information corresponding to the channel state information, and inputting the target feature information into a pre-trained posture detection model and outputting a target posture tag corresponding to the channel state information. During posture detection and identification, the use of wireless networks to reflect human body data is achieved without the requirement for deploying devices for the entire scene, which reduces the cost of detection applications. Moreover, by combining deep learning and the sensing of wireless network signals, it improves the convenience and accuracy of human posture identification and detection.

### FIELD OF INVENTION

The present application relates to the field of human posture detection technology, more particularly to a wireless network-based posture detection method, a device, an electronic apparatus, and a storage medium.

### BACKGROUND OF INVENTION

With the rapid development of smart home technology, it has been widely applied in people's lives and work. For example, in the scenario of elderly home care, in order to improve the timeliness of care, the importance of analyzing human body position and behavioral status has also increased.

Traditionally, infrared signals are often used as sensing signals for detecting and analyzing human body position and behavior. However, due to the insufficient penetration power of infrared signals, sensors need to be arranged in each space. Moreover, if the human body does not move for a while, it may not be detected. Therefore, it is necessary to wave to the sensor at intervals such that it can be detected, resulting in that the detection of human body posture is not inaccurate and timely. Especially in the scenario of elderly home care, in the event of unsafe behaviors such as falling, safety issues may arise due to the failure to detect the posture and alert timely.

Therefore, there is an urgent need for a human posture detection method that improves the convenience and accuracy of detection.

### SUMMARY OF INVENTION

The purpose of the embodiments of the present application is to provide a wireless network-based posture detection method, device, electronic apparatus, and storage medium, in order to solve the technical problems of inconvenient and inaccurate detection of human posture behavior in related technologies.

A first aspect of the embodiment of the present application is to provide a wireless network-based posture detection method which includes: obtaining channel state information collected by a signal collection device from a wireless network; denoising the channel state information and extracting features from the denoised channel state information to obtain target feature information corresponding to the channel state information; and inputting the target feature information into a pre-trained posture detection model and outputting a target posture tag corresponding to the channel state information.

A second aspect of the embodiment of the present application is to provide a wireless network-based posture detection device which includes a data collection module configured for obtaining channel state information collected by a signal collection device from a wireless network, a data processing module configured for denoising the channel state information and extracting features from the denoised channel state information to obtain target feature information corresponding to the channel state information, and a posture determination module configured for inputting the target feature information into a pre-trained posture detection model and outputting a target posture tag corresponding to the channel state information.

A third aspect of the embodiment of the present application is to provide an electronic apparatus which includes a processor, a memory, and a computer program stored in the memory and capable of running on the processor. The processor executes the computer program to implement the steps of any one of aforementioned wireless network-based posture detection methods.

A fourth aspect of the embodiment of the present application is to provide a computer-readable storage medium that stores a computer program. When the computer program is executed by a processor, the steps of any one of aforementioned wireless network-based posture detection methods are implemented.

The embodiments of the present application provide a wireless network-based posture detection method, a device, an electronic apparatus, and a storage medium. When detecting human postures in the environment, channel state information (CSI data) of the wireless network is collected by the arranged signal collection device. Next, the channel state information is denoised, and then features are extracted to obtain feature information corresponding to the channel state information after the completion of denoising. Finally, the pre-trained posture detection model is used for prediction to output a posture tag corresponding to the channel state information. During posture detection and identification, the use of wireless networks to reflect human body data is achieved. Due to the features of the wireless work itself, it is unnecessary to deploy devices for the entire scene, thereby reducing the cost of detection applications. Moreover, by combining deep learning and the sensing of wireless network signals, the convenience and accuracy of human posture identification and detection are improved.

### DESCRIPTION OF DRAWINGS

FIG. 1 is a flowchart illustrating a wireless network-based posture detection method provided in an embodiment of the present application;

FIG. 2 is a flowchart illustrating the steps of obtaining the target feature information provided in an embodiment of the present application;

FIG. 3 is a flowchart illustrating a training process of the posture detection model provided in an embodiment of the present application;

FIG. 4 is a flowchart illustrating the steps of processing training data provided in an embodiment of the present application;

FIG. 5 shows a signal schematic diagram of a certain set of historical channel state information provided in an embodiment of the present application;

FIG. 6 shows a signal schematic diagram of a certain set of historical channel state information that is clipped provided in an embodiment of the present application;

FIG. 7 shows a spectrum schematic diagram of a certain set of historical channel state information which is pre-processed provided in an embodiment of the present application;

FIG. 8 is a flowchart illustrating the steps of obtaining the target feature information provided in an embodiment of the present application;

FIG. 9 is a structure schematic diagram of a wireless network-based posture detection device provided in an embodiment of the present application;

FIG. 10 is a structure schematic diagram of an electronic apparatus provided in an embodiment of the present application;

FIG. 11 is another structure schematic diagram of an electronic apparatus provided in an embodiment of the present application.

### DETAILED DESCRIPTION OF PREFERRED EMBODIMENTS

The following will provide a clear and complete description of the technical solution in the embodiments of the present application with the drawings in the embodiments. Obviously, the described embodiments are only a part of the embodiments of the present application rather than all of them. Based on the embodiments in the present application, all other embodiments obtained by a person of ordinary skill in the art without creative efforts fall within the scope protected by the present application.

It should be realized that various steps recited in the method disclosed herein can be executed in different orders and/or in parallel. In addition, the method may include additional steps and/or omit the steps shown for execution. The scope of this disclosure is not limited in this regard.

The term “comprising” and its variations used in this disclosure are open-ended transitional phrase, which means “including but not limited to”. The term “based on” means “at least partially based on”. The term “one embodiment” means “at least one embodiment”. The term “another embodiment” means “at least one other embodiment”. The term “some embodiments” means “at least some embodiments”. The relevant definitions of other terms will be provided in the following description.

In related technologies, infrared signals are often used as sensing signals for detecting and analyzing human body position and behavior. However, due to the insufficient penetration power of infrared signals, sensors need to be arranged in each space. Moreover, if the human body does not move for a while, it may not be detected. Therefore, it is necessary to wave to the sensor at intervals such that it can be detected. As a result, during the detection of human body posture, not only extensive equipment deployment is required, but also timely and effective detection and analysis cannot be carried out after deployment. Accordingly, the detection and analysis of human body posture are not convenient, timely and accurate enough, and the application cost is also high.

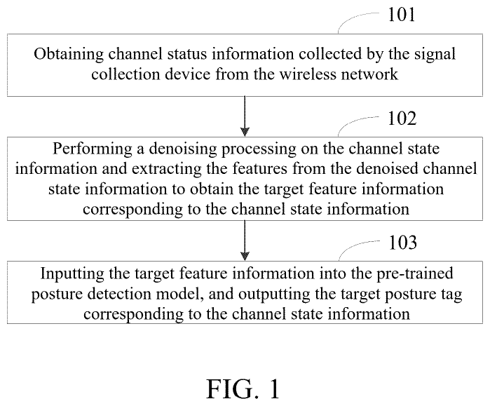

In order to solve the technical problems existing in the relevant technology, an embodiment of the present application provides a wireless network-based posture detection method. Reference is made to FIG. 1. FIG. 1 is a flowchart of a wireless network-based posture detection method provided in an embodiment of the present application, and the method includes steps 101 to 103.

In step 101, the channel state information collected by the signal collection device from the wireless network is obtained.

In one embodiment, during the analyzing processing on the human posture, the channel state information of the wireless network collected by the signal collection device is obtained, and then the posture corresponding to the current collected channel state information is determined by the analyzing processing on the channel state information.

In practical applications, the entire environment is pre-set. The corresponding signal transmitters and receivers are set up in the environment. Then, by using the ping signal transmitter with the corresponding constant signal source, the signal transmitter returns the signal to the signal receiver. By analyzing and processing the signal received by the signal receiver, the posture of the human body in the current environment is determined.

For example, the signal transmitter is a router, and the signal receiver is a Raspberry Pi 4B equipped with the Bcm43455 chip. During the implementation process, the Raspberry Pi Pico w is used as the ping signal source. The Raspberry Pi Pico w continuously pings the router, causing the router to return Wi-Fi signals at a fixed return frequency. The Wi-Fi signals returned by the router are retrieved by nexmon CSI tool as relevant data for detecting human posture, including CSI signals caused by human activity.

Furthermore, the human postures include but not limited to sitting still, standing up, sitting down, walking, and falling. Moreover, due to the timely detection of human posture in the environment, when there is no one in the environment, the posture is nobody.

In step 102, the channel state information is denoised and features are extracted from the denoised channel state information to obtain the target feature information corresponding to the channel state information.

In one embodiment, after collecting the channel state information in the environment, relevant analysis and processing will be carried out. Specifically, the signal state information is denoised, and then the features are extracted after completing the denoising process to obtain the target feature information corresponding to the channel state information, which will be used as the basis for subsequent posture detection and determination.

Specifically, the collected channel state information is generated based on the application of wireless sensing technology in wireless networks. Due to the influence of environment and other factors, the collected channel state information may include useless information, such as noise information. Therefore, before further performing analysis and processing, it is necessary to denoise the channel state information to remove the useless information contained therein. Then perform feature extraction after completing denoising to obtain the target feature information for subsequent analysis and processing.

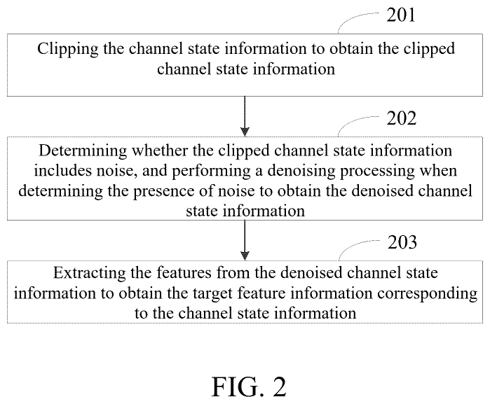

Furthermore, reference is made to FIG. 2. FIG. 2 is a flowchart of the steps to obtain the target feature information provided in an embodiment of the present application, wherein said step include steps 201 to 203.

In step 201, the channel state information is clipped to obtain the clipped channel state information. In step 202, the determination is made as to whether the clipped channel state information includes noise, and a denoising processing is performed to obtain the denoised channel state information when the clipped channel state information is determined to include noise. In step 203, features are extracted from the denoised channel state information to obtain the target feature information corresponding to the channel state information.

For example, when collecting the channel state information of the wireless network, it itself includes a certain amount of noise data. Therefore, after obtaining the channel state information, a clipping processing is performed on it to remove the regular noise included in the channel state information and obtain the denoised channel state information without regular noise. Next, the determination is made as to whether the denoised channel state information still includes noise, and the denoising processing is performed again to obtain the denoised channel state information when the denoised channel state information includes noise. Finally, features are extracted from the denoised channel state information to obtain the target feature information corresponding to the channel state information.

In general, when collecting the channel state information (CSI data) of the wireless network, the collected channel state information includes 64 subcarriers, with a range of values from 0 to 35,000. Moreover, the regular noise are several subcarriers among them, such as the 1^{st}-2^{nd}, 28^{th}, 36^{th}, and 64^{th} subcarriers which. When performing the clipping processing, the subcarriers that belong to noise are clipped to obtain 52 subcarriers with complete actions.

After completing the clipping processing for the channel state information, the regular noise included therein is removed. However, since the channel state information may include noise with extremely low frequency, the determination will be made so to whether the clipped channel state information still includes noise, in order to obtain the completely denoised channel state data.

When further processing the clipped channel state information, fast Fourier transform is performed on it, and spectral analysis is used to identify the noise components with extremely low frequency in the clipped channel state information. The standard deviation of the data can be compared with the set threshold to determine whether it is noise. When determining the presence of extremely low frequency noise, the sequence with the extremely low frequency noise is removed, and the adjacent previous sequence data is used to supplement the data to ensure data integrity.

In step 103, the target feature information is inputted into a pre-trained posture detection model, and a target posture tag corresponding to the channel state information is outputted.

In one embodiment, after completing the processing of the channel state information and obtaining the target feature information, the target feature information is inputted into a pre-trained posture detection model to output the posture tag corresponding to the obtained channel state information. Based on the aforementioned posture settings, the posture tags include but not limited to the tags such as sitting still, standing up, sitting down, walking, falling, vacant environments, etc. Moreover, the tags can be modified and added or removed according to actual situations and needs.

For example, the current posture detection model is pre-trained based on relevant historical data, wherein the historical data is the historical channel state information of the wireless network. By previously obtaining the corresponding historical data, processing and extracting features from the historical data, the constructed posture detection model is trained and adjusted. Then, a trained posture detection model for posture determination is obtained upon completion of training.

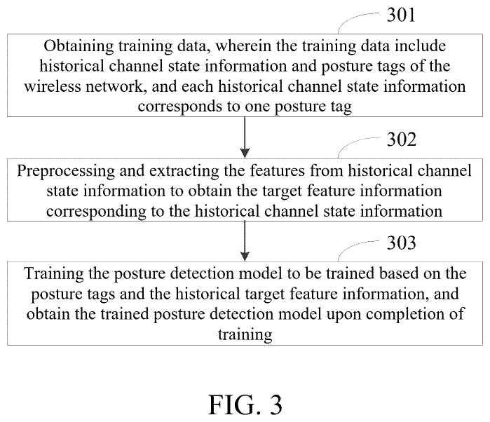

Reference is made to FIG. 3. FIG. 3 is a flowchart of a training process of the posture detection model provided in an embodiment of the present application, wherein the process includes steps 301 to 303.

In step 301, training data is obtained, wherein the training data includes the historical channel state information of the wireless network and posture tags, wherein each historical channel state information is corresponding to to one of the posture tags. In step 302, historical channel state information is preprocessed and features are extract therefrom to obtain the target feature information corresponding to historical channel state information. In step 303, the posture detection model to be trained is trained based on the posture tags and the historical target feature information, and the trained posture detection model is obtained upon completion of training.

In one embodiment, during training the posture detection model, relevant training data is obtained. The training data includes the historical channel state information of the wireless network and the posture tags, wherein each historical channel state information is corresponding to one of the posture tags. Then, the historical channel state information is preprocessed and features are extracted therefrom to obtain the target feature information corresponding to the historical channel state information, wherein the data for feature extraction is the preprocessed historical channel state information. Finally, the posture detection model to be trained is trained based on the posture tags and the target feature information, and the trained posture detection model is obtained upon completion of training. The condition for training completion may be that the number of training times reaches the set threshold, and the parameter can be further adjusted to meet the set conditions.

Based on the environmental state described above, the obtained historical channel state information is the Wi-Fi signals retrieved from the router over a period of time, wherein the Wi-Fi signals include the variation of the CSI signals caused by the human activity. Each action data will generate a binary document (bin file). For stationary posture, the data corresponding to each of the posture tags includes at least 250 data points, and each piece of data is collected for 20 seconds. Moreover, each set of data includes 64 subcarriers.

Furthermore, similar to using the trained posture detection model for posture detection analysis, it is necessary to perform relevant preprocessing on the historical state information after obtaining the historical channel state information, which is the same as the processing process described in step 102 and related embodiments. Specifically, after obtaining the training data, clipping, denoising, and feature extraction are performed on each set of data in the training data to obtain the feature information corresponding to each set of data.

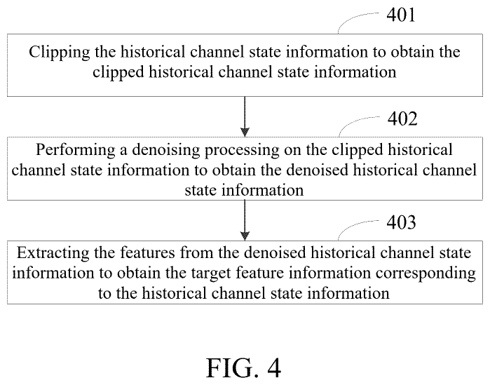

Specifically, processing the training data to obtain the target feature information may refer to FIG. 4. FIG. 4 is a flowchart of the steps for processing the training data provided in an embodiment of the present application, wherein said step includes steps 401 to 403.

In step 401, the historical channel state information is clipped to obtain the clipped historical channel state information. In step 402, the clipped historical channel state information is denoised to obtain the denoised historical channel state information. In step 403, features are extracted from the denoised historical channel state information to obtain the target feature information corresponding to the historical channel state information.

For example, during processing the historical channel state information, it is clipped firstly to obtain the clipped historical channel state information. Then, the clipped historical channel state information is denoised to obtain the denoised historical channel state information. Finally, the feature information extraction is performed to obtain the feature information corresponding to each set of data in the historical channel state information, wherein each feature information is associated with the posture tag of the data corresponding thereto.

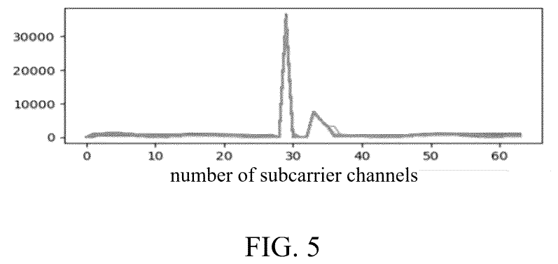

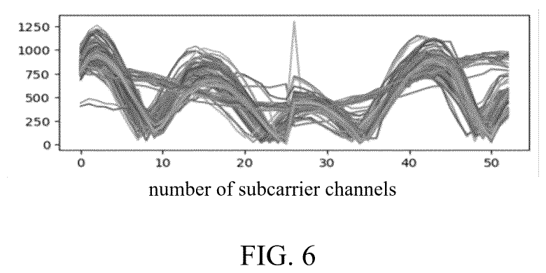

Taking a certain set of historical channel state information as an example. Reference is made to FIG. 5. FIG. 5 shows a signal schematic diagram of a certain set of historical channel state information provided in an embodiment of the present application. At this time, when performing clipping processing, the regular noise included therein is removed. The regular noise is shown as the protruding part in FIG. 5. Specifically, through analysis, it can be determined that the regular noise corresponds to the data of 1^{th}-2^{nd}, 28^{th}_36^{th}, and64^{th} subcarriers. Then, when performing the clipping processing, the regular noise (1^{st}-2^{nd}, 28^{th}_36th, and64^{th} subcarriers) is removed to obtain one historical channel state information of 52 subcarriers with completed action data, as shown in FIG. 6. FIG. 6 shows a signal schematic diagram of a certain set of clipped historical channel state information provided in an embodiment of the present application. The data included therein at this point is the signal data of the entire action included.

Therefore, clipping the historical channel state information includes: performing a first noise analysis on the historical channel state information to obtain the first noise included in the historical channel state information; removing the first noise in the historical channel state information to obtain the historical channel state information without the first noise.

That is, the noise included in the historical state information is analyzed and identified to determine the first noise included therein. Then, the first noise is removed to obtain the historical channel state information that does not include the first noise. In other words, the regular noise (the first noise, i.e., 1^{th}-2^{nd}, 28^{th}_36^{th}, and64^{th} subcarriers) is clipped out from the historical channel data of 64 subcarriers to obtain one historical channel state information of 52 subcarriers.

Furthermore, after removing the regular noise from the historical channel state information, filtering can be performed to suppress high-frequency noise that is not smooth in the signal and low-frequency noise that causes the overall upward displacement of the signal, thereby ensuring the smoothness of each set of historical channel state information. Specifically, a Butterworth bandpass filter can be used to filter the clipped historical channel state information, with the order set as 1 and a cutoff frequency set from 0.05 Hz to 0.25 Hz. The signal data can be smoothed through filtering while retaining the signal data generated by human activities. The signal diagram of a certain set of historical channel state information after filtering may refer to FIG. 6.

Next, during the processing, when removing the extremely low frequency noise from the historical channel state information, fast Fourier transform and spectrum analysis methods can be used to determine whether there is extremely low frequency noise included, and denoising processing is performed when determining the presence of noise. Taking FIG. 6 as an example, the extremely low frequency noise is the smoother one in FIG. 6. Certainly, not all channel state information includes extremely low frequency noise. Therefore, when processing, the determination is firstly made to whether there is extremely low frequency noise, and then remove it when its presence is determined. Specifically, the step includes: performing a second noise analysis on the clipped historical channel state information; when it is determined that there is noise during the second noise analysis, the second noise obtained by the analysis is removed, and the historical channel state information of which the second noise is removed is filled with data to obtain the denoised historical channel state information; when it is determined that there is no noise during the second noise analysis, the clipped historical channel state information is taken as the denoised historical channel state information.

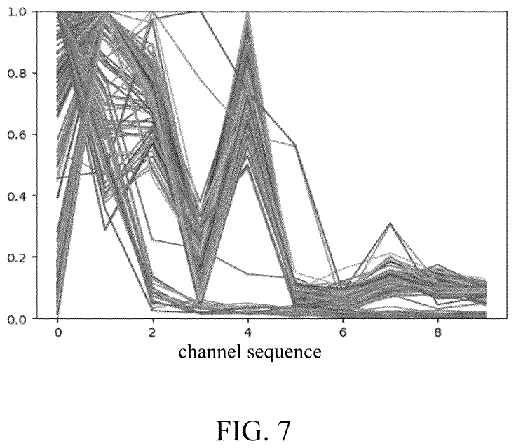

During the processing, fast Fourier transform is performed on the clipped and filtered historical channel state information to obtain its corresponding spectrogram. Reference is made to FIG. 7. FIG. 7 shows a spectrum schematic diagram of a certain set of historical channel state information provided in an embodiment of the present application. As shown in FIG. 7, the noise frequency drops to almost zero in sequence 2, while the normal signal has a higher value in sequence 1 than both sequence 0 and sequence 2. At this point, by calculating the standard deviation of the sequence and setting a threshold, the determination is made to whether it is strip-shaped noise, i.e., extremely low frequency noise.

The specific calculation and determination methods are:
1. fft_std010>0.29: check whether the standard deviation of the first 10 frequency sequences is greater than 0.29.
2. fft_std010<0.275: check whether the standard deviation of the first 10 frequency sequences is less than 0.275.
3. fft_std02<0.35: check whether the standard deviation of the first two frequency sequences is less than 0.35.

After performing the processing based on the above methods, the historical channel state information shown in FIG. 6 will become a signal without extremely low frequency noise, as shown in FIG. 7. FIG. 7 shows a signal schematic diagram of a set of historical channel state information after preprocessing provided in an embodiment of the present application.

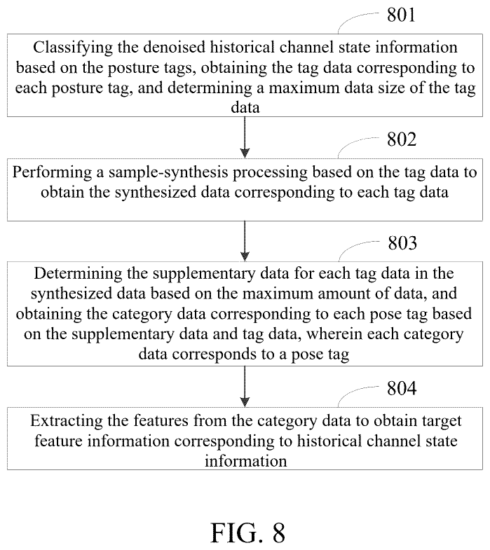

Furthermore, after completing the denoising process for the historical channel state information, the target feature information will be extracted, as shown in FIG. 8. FIG. 8 is a flowchart of the step of obtaining the target feature information provided in an embodiment of the present application, wherein said step includes steps 801 to 804.

In step 801, the denoised historical channel state information is classified based on the posture tags to obtain the tag data corresponding to each of the posture tags, wherein a maximum amount of data of the tag data is determined. In step 802, a sample-synthesis processing is performed based on the tag data to obtain the synthesized data corresponding to each of the tag data. In step 803, the determination is made so to the supplementary data for each of the tag data in the synthesized data based on the maximum amount of data, and the category data corresponding to each of the posture tags is obtained based on the supplementary data and tag data, wherein each of the category data is corresponding to one of the posture tags. In step 804, features are extracted from the category data to obtain the target feature information corresponding to historical channel state information.

In one embodiment, when extracting the target feature information, in order to avoid the model overfitting towards a certain posture or some postures during the training process, the consistency of the amount of training data for different postures is ensured by data synthesis. Specifically, after completing the processing of the historical channel state information to obtain the denoised historical channel state information, a classification processing is carried out based on the posture tags to determine the tag data corresponding to each of the posture tags. Moreover, the amount of data included in each of the tag data is identified to obtain a maximum amount of data. Then, sample data is synthesized for each of the tag data to obtain the synthesized data corresponding to each of the tag data, wherein the synthesized data includes a certain amount of data. Next, supplementary data for each of the tag data is determined in the synthesized data according to the maximum amount of data, so as to obtain the category data corresponding to each of the posture tags in the historical channel state information. Finally, the target feature information is extracted from the category data to obtain the target feature information corresponding to the historical channel state information.

For example, before extracting the target feature information, the sample data is synthesized to ensure that the amount of train data corresponding to each of the posture tags are consistent, thereby avoiding overfitting during the training process.

When synthesizing the sample data, the posture with the largest amount of data can be determined, and the maximum amount of data can be used as a supplementary standard for the data corresponding to each of the posture tags. For example, if the maximum amount of data is 200, after completing sample-synthesis and data supplementation, the amount of data corresponding to each of the posture tags is 200. When synthesizing the sample data, the SMOTE algorithm can be used to generate the synthesized samples.

Specifically, for each selected minority category sample (training data corresponding to the posture tags other than the maximum amount of data), its k nearest samples are found out, one of the k samples is randomly selected, and a new synthesized sample is generated by using the following formula:

$${x}_{new} = {x}_{chosen} + ( {x}_{nearest} - {x}_{chosen} ) * δ ;$$

x_{new} is the synthesized sample, x_{chosen} is the selected minority category sample, and xₙₑₐᵣₑₛₜ is a randomly selected sample from k nearest samples, δ∈[0,1] oversampling ensures that a small number of samples are equal in size to other samples, and the best way to ensure data consistency is to use the maximum amount of data as a reference.

Furthermore, after completing the target feature information extraction, the constructed posture detection model is trained. When constructing the posture detection model, the deep learning model of Long Short Term Memory Network (LSTM) can be used to extract the features from the processed CSI data. The extracted features are then classified with the actual data to identify the human posture.

During the training process, forward propagation is first performed. The model processes each input data, passes information through the layers of the network, and finally generates the corresponding output. Subsequently, cross-entropy loss is calculated to quantify the difference between the model's predicted results and the actual tags.

The formula for cross-entropy loss is showed as follows:

$$L ( p , q ) = - \sum p ( x ) log ( q ) ;$$

p is the actual category, and q is the distribution predicted by the model.

Next, backpropagation is then performed. During backpropagation, the calculated loss is propagated backward through the entire network by using gradient descent to adjust the weights and errors of the model. Moreover, the Adam optimizer is used to automatically adjust the weights and errors of the model to minimize the loss function. 10-fold cross-validation is employed during the training to evaluate the performance of the machine learning model. Performance indicators obtained by ten iterations are averaged to obtain the final performance evaluation of the model, thereby determining whether the training of the posture detection model is completed.

In summary, the present application discloses a wireless network-based posture detection method. When detecting the human posture in the environment, the channel state information (CSI data) of the wireless network collected by the arranged signal collection device is obtained. Then, the channel state information is denoised, and the feature extraction is performed to obtain the target feature information corresponding to the channel state information after completing the denoising. Finally, the pre-trained posture detection model is used for prediction to output a posture tag corresponding to the channel state information. During posture detection and identification, the use of wireless networks to reflect human body data is achieved. Due to the features of the wireless work itself, it is unnecessary to deploy devices for the entire scene, thereby reducing the cost of detection applications. Moreover, by combining deep learning and the sensing of wireless network signals, the convenience and accuracy of human posture identification and detection are improved.

According to the method described in the above embodiment, the present embodiment further describes from the perspective of a wireless network-based posture detection device. The wireless network-based posture detection device can be implemented as an independent entity or integrated into an electronic apparatus, such as a terminal, which can include a mobile phone, tablet, etc.

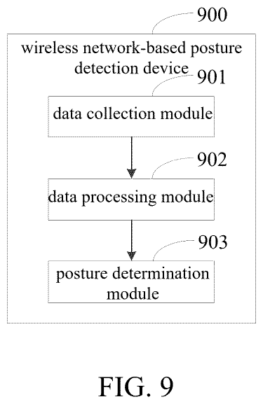

Reference is made to FIG. 9. FIG. 9 is a structure schematic diagram of a wireless network-based posture detection device provided in an embodiment of the present application. As shown in FIG. 9, the wireless network-based posture detection device 900 provided in an embodiment of the present application includes a data collection module 901 configured for obtaining channel state information collected by a signal collection device from a wireless network, a data processing module 902 configured for denoising the channel state information and extracting features from the denoised channel state information to obtain target feature information corresponding to the channel state information, and a posture determination module 903 configured for inputting the target feature information into a pre-trained posture detection model and outputting a target posture tag corresponding to the channel state information.

In one embodiment, the data processing module 902 is further configured for clipping the channel state information to obtain the clipped channel state information, determining whether the clipped channel state information includes noise, and performing a denoising processing to obtain the denoised channel state information when it is determined that there is noise, and extracting the features from the denoised channel state information to obtain the target feature information corresponding to the channel state information.

In one embodiment, the wireless network-based posture detection device 900 further includes a model training module, which is configured for obtaining training data, wherein the training data includes the historical channel state information and the posture tags of the wireless network, and each historical channel state information is corresponding to one of the posture tags, preprocessing and extracting features from the historical channel state information to obtain the feature information corresponding to the historical channel state information, and training the posture detection model to be trained based on the posture tags and the historical feature information, and obtaining the trained posture detection model upon completion of training.

In one embodiment, the model training module is further configured for clipping the historical channel state information to obtain the clipped historical channel state information, denoising the clipped historical channel state information to obtain the denoised historical channel state information, and extracting the features from the denoised historical channel state information to obtain the feature information corresponding to the historical channel state information.

In one embodiment, the model training module is further configured for performing a first noise analysis on the historical channel state information to obtain a first noise included in the historical channel state information, and removing the first noise in the historical channel state information to obtain the historical channel state information without the first noise.

In one embodiment, the model training module is further configured for performing a second noise analysis on the clipped historical channel state information, removing a second noise obtained from the second noise analysis when a presence of noise is determined during the second noise analysis, and filling the historical channel state information of which the second noise is removed with data to obtain the denoised historical channel state information, and taking the clipped historical channel state information as the denoised historical channel state information when it is determined that there is no noise present during the second noise analysis.

In one embodiment, the model training module is further configured for classifying the denoised historical channel state information based on the posture tags, obtaining the tag data corresponding to each of the posture tags, and determine a maximum amount of data of the tag data, performing a sample-synthesis processing based on the tag data to obtain synthesized data corresponding to each of the tag data, determining supplementary data for each of the tag data in the synthesized data based on the maximum amount of data, and obtaining category data corresponding to each of the posture tags based on the supplementary data and the tag data, wherein each of the category data is corresponding to one of the posture tags, and extracting the features from the category data to obtain the feature information corresponding to the historical channel state information.

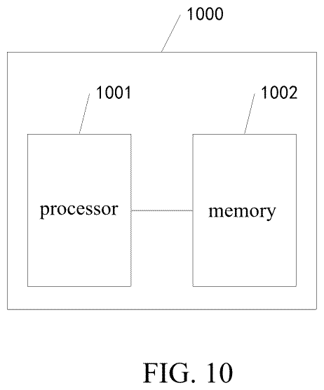

Moreover, reference is made to FIG. 10. FIG. 10 is a structure schematic diagram of an electronic apparatus provided in an embodiment of the present application. The electronic apparatus may be a mobile terminal such as a smartphone, tablet, etc. As shown in FIG. 10, the electronic apparatus 1000 includes a processor 1001 and a memory 1002, wherein the processor 1001 is electrically connected to memory 1002.

The processor 1001 is the control center of the electronic apparatus 1000, and it connects various parts of the entire electronic apparatus through various interfaces and circuits. By running or loading application programs stored in the memory 1002 and calling the data stored in the memory 1002, it executes various functions and processes data of the electronic apparatus 1000, thereby monitoring the overall electronic apparatus 1000.

In the present embodiment, the processor 1001 of the electronic apparatus 1000 may load instructions corresponding to one or more application programs into the memory 1002 according to the following steps, and the processor 1001 may run the application programs stored in the memory 1002 to implement any step in the wireless network-based posture detection method provided in the above embodiments.

The electronic apparatus 1000 can implement the steps in any embodiment of the wireless network-based posture detection method provided in the present application. Therefore, the beneficial effects that can be achieved by any wireless network-based posture detection method provided in an embodiment of the present application can be achieved. The details may refer to the previous embodiments and thus no further description is provided.

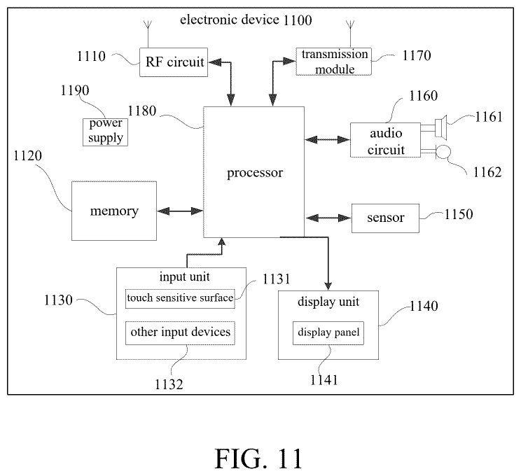

Reference is made to FIG. 11. FIG. 11 is another structure schematic diagram of an electronic apparatus provided in an embodiment of the present application. As shown in FIG. 11. FIG. 11 shows a specific structural diagram of the electronic apparatus provided in an embodiment of the present application, which can be used to implement the wireless network-based posture detection method provided in the above embodiments. The electronic apparatus 1100 may be used a mobile terminal such as a smartphone, laptop, etc.

The RF circuit 1110 is configured for receiving and transmitting electromagnetic waves and implementing mutual conversion between electromagnetic waves and electrical signals, thereby communicating with communication networks or other devices. The RF circuit 1110 may include various existing circuit components for performing these functions, such as antennas, RF transceivers, digital signal processors, encryption/decryption chips, subscriber identity module (SIM) cards, memory, and so on. The RF circuit 1110 can communicate with various networks, such as the Internet, enterprise intranet, wireless network or other devices through wireless network. The above wireless networks may include cellular telephone networks, wireless local area networks, or metropolitan area networks. The above wireless networks can use various communication standards, protocols, and technologies, including but not limited to Global System for Mobile Communication (GSM), Enhanced Data GSM Environment (EDGE), Wideband Code Division Multiple Access (WCDMA), Code Division Multiple Access (CDMA), Time Division Multiple Access (TDMA), Wireless Fidelity (Wi-Fi) (e.g., IEEE 802.11a, IEEE 802.11b, IEEE 802.11g and/or IEEE 802.11n), Voice over Internet Protocol (VoIP), Worldwide Interoperability for Microwave Access (Wi-Max), other protocols used for email, instant messaging, and short messaging, as well as any other suitable communication protocols, even including protocols that have not yet been developed.

The memory 1120 can be configured for storing software programs and modules, such as program instructions/modules corresponding to wireless network-based posture detection methods in the above embodiments. The processor 1180 executes various function applications and wireless network-based posture detection methods by running the software programs and modules stored in the memory 1120.

The memory 1120 may include high-speed random-access memory and may also include non-volatile memory, such as one or more magnetic storage devices, flash memory, or other non-volatile solid-state memory. In some instances, memory 1120 may further include the memory remotely arranged relative to processor 1180, which can be connected to the electronic apparatus 1100 through the network. Examples of the above network include but not limited to the Internet, enterprise intranet, local area network, mobile communication network and their combinations.

The input unit 1130 may be configured for receiving uploaded digital or character information, as well as generating the signal inputs of the keyboard, mouse, joystick, optical or trackball related to user settings and functional control. Specifically, the input unit 1130 may include a touch sensitive surface 1131 and other input devices 1132. The touch sensitive surface 1131, also known as a touch display screen or touchpad, can collect user touch operations on or near it (e.g., the user uses any suitable object or accessory such as fingers, stylus, etc. to operate on or near the touch sensitive surface 1131), and drive corresponding connection devices according to pre-set programs. Optionally, the touch sensitive surface 1131 may include two parts: a touch detection device and a touch controller. The touch detection device detects the user's touch direction, detects the signal brought by the touch operation, and transmits the signal to the touch controller. The touch controller receives the touch information from the touch detection device, converts it into touch coordinates, and sends them to the processor 1180. It can also receive commands from the processor 1180 and execute them. Moreover, the touch sensitive surface 1131 can be implemented in various types such as resistive, capacitive, infrared, and surface acoustic waves. In addition to the touch sensitive surface 1131, the input unit 1130 may also include other input devices 1132. Specifically, other input devices 1132 may include but not limited to one or more of physical keyboards, function keys (e.g., volume control buttons, switch buttons, etc.), trackballs, mouse, joysticks, etc.

The display unit 1140 may be configured for displaying information inputted by the user or provided to the user and various graphical user interfaces of the electronic apparatus 1100, which can be composed of graphics, text, icons, videos, and any combination thereof. The display unit 1140 may include a display panel 1141, which can be optionally configured in the form of LCD (Liquid Crystal Display), OLED (Organic Light-Emitting Diode), or other devices. Furthermore, the touch sensitive surface 1131 can cover the display panel 1141. When the touch sensitive surface 1131 detects the touch operations on or near it, they are transmitted to the processor 1180 to determine the type of touch event. Subsequently, the processor 1180 provides corresponding visual output on the display panel 1141 based on the type of touch event. Although in the figure, the touch sensitive surface 1131 and the display panel 1141 are used as two independent components to achieve input and output functions, in some embodiments, the touch sensitive surface 1131 can be integrated with the display panel 1141 to achieve input and output functions.

The electronic apparatus 1100 may also include at least one sensor 1150, such as a light sensor, a motion sensor, and other sensors. Specifically, the light sensor may include an ambient light sensor and a proximity sensor, wherein the ambient light sensor can adjust the brightness of the display panel 1141 based on the brightness of the ambient light, and the proximity sensor may be interrupted when the flip is closed or turned off. As a type of the motion sensor, a gravity acceleration sensor can detect the magnitude of acceleration in various directions (usually three-axis), and can detect the magnitude and direction of gravity when stationary. It can be used for applications that recognize mobile phone posture (e.g., horizontal and vertical screen switching, related games, magnetometer posture calibration), vibration identification related functions (e.g., pedometer, tapping), etc. The electronic apparatus 1100 may be further equipped with other sensors such as gyroscopes, barometers, hygrometers, thermometers, infrared sensors, etc., and the further description will not be provided herein.

The audio circuit 1160, the speaker 1161, and the microphone 1162 can provide an audio interface between the user and electronic apparatus 1100. The audio circuit 1160 can convert the received audio data into the electrical signals and transmit them to the speaker 1161, and the speaker 1161 then converts them into sound signals for output. On the other hand, the microphone 1162 converts the collected sound signals into the electrical signals, which are received and converted into audio data by the audio circuit 1160. The audio data is then outputted to the processor 1180 for processing and sent to another terminal through the RF circuit 1110, or the audio data is outputted to the memory 1120 for further processing. The audio circuit 1160 may further include an earplug jack to provide communication between external headphones and electronic apparatus 1100.

The electronic apparatus 1100 can receive requests, send information, etc. through the transmission module 1170 (e.g., the Wi-Fi module), which provides users with wireless wideband Internet access. Although the transmission module 1170 is shown in the figure, it can be understood that it is not a necessary component in the electronic apparatus 1100 and can be omitted as needed within the scope of not changing the essence of the invention.

The processor 1180 is the control center of the electronic apparatus 1100, and it connects various parts of the entire mobile phone through various interfaces and wires. By running or executing software programs and/or modules stored in the memory 1120 and calling data stored in the memory 1120, it performs various functions and processes data of the electronic apparatus 1100, thereby monitoring the overall electronic apparatus. Optionally, the processor 1180 may include one or more processing cores. In some embodiments, the processor 1180 may integrate an application processor and a modulation and demodulation processor, wherein the application processor mainly processes the operating system, user interface, and application programs, and the modulation and demodulation processor mainly processes wireless communication. It can be understood that the aforementioned modulation and demodulation processor may not be integrated into the processor 1180.

The electronic apparatus 1100 also includes a power supply 1190 (e.g., a battery) that supplies power to various components. In some embodiments, the power supply can be logically connected to the processor 1180 through a power management system, thereby achieving functions such as charging, discharging, and power consumption management through the power management system. The power supply 1190 can also include one or more DC or AC power supplies, a recharging system, a power fault detection circuit, a power converter or inverter, a power status indicator, and any other component.

Although it is not shown in the figure, the electronic apparatus 1100 also includes cameras (e.g., front cameras, rear cameras), Bluetooth modules, etc., of which the further description is not provided. In this embodiment, the display unit of the electronic apparatus is a touch screen display, and the mobile terminal further includes a memory and one or more programs, wherein the one or more programs are stored in the memory and configured to be executed by one or more processors to implement any step of the wireless network-based posture detection method provided in the above embodiments.

In specific implementation, the above modules can be implemented as independent entities or they can be arbitrarily combined to be implemented as the same entity or several entities. The specific implementation of the above modules may refer to the previous embodiments of the method, and thus no further description is provided.

It can be understood for a person of ordinary skill in the art that all or part of the steps in the various methods of the above embodiments can be completed through instructions, or by the hardware related to instruction-controlling, wherein the instructions can be stored in a computer-readable storage medium and loaded and executed by the processor. For this purpose, the present embodiment provides a storage medium that stores multiple instructions that can be executed by a processor to implement any step of the wireless network-based posture detection method provided in the above embodiments.

The storage medium may include Read Only Memory (ROM), Random Access Memory (RAM), disk or optical disc, etc.

Since the instructions stored in the storage medium can execute the steps in any embodiment of the wireless network-based posture detection method provided in the present application, the beneficial effects that can be achieved by any wireless network-based posture detection method provided in an embodiment of the present application can be achieved. The details may refer to the previous embodiments and thus no further description is provided.

The detailed introduction to a wireless network-based posture detection method, a device, an electronic apparatus, and a storage medium provided in the embodiments of the present application are provided above. Specific examples are applied in this disclosure to explain the principles and implementation methods of the present application. The above embodiments are only used to help understand the methods and core ideas of the present application. Moreover, for a person of ordinary skill in the art, there may be changes in specific implementation methods and application scope based on the ideas of the present application. In summary, the attributes of this specification should not be understood as restrictions on the present application. Moreover, for ordinary technical personnel in this field, several improvements and embellishments can be made without departing from the principles of the present application, and these improvements and embellishments are also considered within the scope of protection of the present application.

What is claimed is:

1. A wireless network-based posture detection method, comprising:
obtaining channel state information collected by a signal collection device from a wireless network;
denoising the channel state information and extracting features from the denoised channel state information to obtain target feature information corresponding to the channel state information; and
inputting the target feature information into a pre-trained posture detection model and outputting a target posture tag corresponding to the channel state information.

2. The method as claimed in claim 1, wherein denoising the channel state information and extracting the features from the denoised channel state information to obtain the target feature information corresponding to the channel state information comprises:
clipping the channel state information to obtain the clipped channel state information;
determining whether the clipped channel state information comprises noise, and performing a denoising processing to obtain the denoised channel state information when the clipped channel state information is determined to comprise noise; and
extracting the features from the denoised channel state information to obtain the target feature information corresponding to the channel state information.

3. The method as claimed in claim 1, wherein a training process of the pre-trained posture detection model comprises:
obtaining training data, wherein the training data comprises historical channel state information and posture tags of the wireless network, and each historical channel state information is corresponding to one of the posture tags;
preprocessing and extracting features from the historical channel state information to obtain the feature information corresponding to the historical channel state information; and
training the posture detection model to be trained based on the posture tags and the historical feature information, and obtaining the trained posture detection model upon completion of training.

4. The method as claimed in claim 3, wherein preprocessing and extracting the features from the historical channel state information to obtain the feature information corresponding to the historical channel state information comprises:
clipping the historical channel state information to obtain the clipped historical channel state information;
denoising the clipped historical channel state information to obtain the denoised historical channel state information; and
extracting the features from the denoised historical channel state information to obtain the feature information corresponding to the historical channel state information.

5. The method as claimed in claim 4, wherein clipping the historical channel state information to obtain the clipped historical channel state information comprises:
performing a first noise analysis on the historical channel state information to obtain a first noise included in the historical channel state information; and
removing the first noise in the historical channel state information to obtain the historical channel state information without the first noise.

6. The method as claimed in claim 4, wherein denoising the clipped historical channel state information to obtain the denoised historical channel state information comprises:
performing a second noise analysis on the clipped historical channel state information;
removing a second noise obtained from the second noise analysis when a presence of noise is determined during the second noise analysis, and filling the historical channel state information of which the second noise is removed with data to obtain the denoised historical channel state information; and
taking the clipped historical channel state information as the denoised historical channel state information when it is determined that there is no noise present during the second noise analysis.

7. The method as claimed in claim 4, wherein extracting the features from the denoised historical channel state information to obtain the feature information corresponding to the historical channel state information comprises:
classifying the denoised historical channel state information based on the posture tags, obtaining the tag data corresponding to each of the posture tags, and determine a maximum amount of data of the tag data;
performing a sample-synthesis processing based on the tag data to obtain synthesized data corresponding to each of the tag data;
determining supplementary data for each of the tag data in the synthesized data based on the maximum amount of data, and obtaining category data corresponding to each of the posture tags based on the supplementary data and the tag data, wherein each of the category data is corresponding to one of the posture tags; and
extracting the features from the category data to obtain the feature information corresponding to the historical channel state information.

8. A wireless network-based posture detection device, comprising:
a data collection module configured for obtaining channel state information collected by a signal collection device from a wireless network;
a data processing module configured for denoising the channel state information and extracting features from the denoised channel state information to obtain target feature information corresponding to the channel state information; and
a posture determination module configured for inputting the target feature information into a pre-trained posture detection model and outputting a target posture tag corresponding to the channel state information.

9. An electronic apparatus, wherein the electronic apparatus comprises a processor, a memory, and a computer program stored in the memory and capable of running on the processor, wherein the processor executes the computer program to implement steps of a wireless network-based posture detection method, wherein the wireless network-based posture detection method comprises:
obtaining channel state information collected by a signal collection device from a wireless network;
denoising the channel state information and extracting features from the denoised channel state information to obtain target feature information corresponding to the channel state information; and
inputting the target feature information into a pre-trained posture detection model and outputting a target posture tag corresponding to the channel state information.
